(19) United States
(12) Patent Application Publication
(10) Pub. No.: US 2025/0280759 A1
(43) Pub. Date: Sep. 11, 2025

(54) MOWER WITH MOTOR BRACKETS

(71) Applicant: Textron Inc., Providence, RI (US)

(72) Inventors: Giles Wilson, Ipswich (GB); Jonathan Gibbs, Stowmarket (GB)

(73) Assignee: Textron Inc., Providence, RI (US)

(21) Appl. No.: 18/595,998

(22) Filed: Mar. 5, 2024

(51) Int. Cl. A01D 34/44; A01D 34/54; A01D 34/58; A01D 101/00

(52) U.S. Cl. CPC A01D 34/44; A01D 34/54; A01D 34/58; A01D 2101/00

(57) ABSTRACT

A mower includes a chassis, a tractive element coupled to the chassis, a cutting unit coupled to the chassis and including a cutting element, a mounting bracket coupled to the chassis, and a motor configured to drive the cutting element. The motor is configured to be removably coupled to the cutting unit and configured to be removably coupled to the mounting bracket. The mower is reconfigurable between (a) an operating configuration in which the motor is removed from the mounting bracket and coupled to the cutting unit and (b) a service or transportation configuration in which the motor is removed from the cutting unit and coupled to the mounting bracket.

### BACKGROUND

The present disclosure relates generally to mowers. More specifically, the present disclosure relates to a cutting unit for a mower.

Mowers are used to maintain vegetation (e.g., grass, clover, weeds, etc.) at a desired height. To accomplish this, mowers include at least one cutting unit having a cutting element that is driven by a motor. When performing maintenance or during transportation, the cutting units may be removed. However, the motors may remain coupled to a chassis of the mower (e.g., by one or more cables), even after the other portions of the cutting units are removed. Permitting these motors to hang freely from the chassis may cause them to become tangled or otherwise become damaged.

### SUMMARY

One embodiment relates to a mower. The mower includes a chassis, a tractive element coupled to the chassis, a cutting unit removably coupled to the chassis and including a cutting element, a mounting bracket coupled to the chassis, and a motor configured to drive the cutting element. The motor is configured to be removably coupled to the cutting unit and configured to be removably coupled to the mounting bracket. The mower is reconfigurable between (a) an operating configuration in which the motor is removed from the mounting bracket and coupled to the cutting unit and (b) a service or transportation configuration in which the motor is removed from the cutting unit and coupled to the mounting bracket.

Another embodiment relates to a mower. The mower includes a chassis, a tractive element coupled to the chassis, a cutting unit coupled to the chassis and including a cutting element, an actuator configured to raise the cutting unit relative to the chassis, a mounting bracket coupled to the chassis, the mounting bracket defining a first fastener passage and a second fastener passage, a motor configured to drive the cutting element, the motor defining a first fastener aperture and a second fastener aperture, a first fastener, and a second fastener. The mower is reconfigurable between a first configuration and a second configuration. In the first configuration, (a) the first fastener extends through the first fastener aperture and engages the cutting unit and (b) and the second fastener extends through the second fastener aperture and engages the cutting unit. In the second configuration, (a) the first fastener extends through the first fastener aperture and into the first fastener passage to couple the motor to the mounting bracket and (b) the second fastener extends into the second fastener passage without extending through the second fastener aperture.

Still another embodiment relates to a mower. The mower includes a chassis, a tractive element coupled to the chassis, a first cutting unit configured to be driven by a first motor, a second cutting unit configured to be driven by a second motor, a first mounting bracket pivotally coupled to the chassis, and a second mounting bracket fixedly coupled to the chassis. The mower is reconfigurable between a first configuration and a second configuration. In the first configuration, (a) the first motor is coupled to the first cutting unit and (b) the second motor is coupled to the second cutting unit. In the second configuration, (a) the first motor is disconnected from the first cutting unit and coupled to the first mounting bracket and (b) the second motor is disconnected from the second cutting unit and coupled to the second mounting bracket.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a perspective view of a mower, according to an exemplary embodiment.

FIG. 2 is a schematic block diagram of the mower of FIG. 1, according to an exemplary embodiment.

FIG. 3 is a perspective view of the mower of FIG. 1 in a service configuration.

FIG. 4 is a front perspective view of a motor coupled to a front cutting unit of the mower of FIG. 1.

FIG. 5 is a front perspective view of a lift arm for the front cutting unit of FIG. 4.

FIG. 6 is a rear view of the lift arm of FIG. 5.

FIG. 7 is a rear perspective view of the lift arm of FIG. 5 installed on the mower of FIG. 1.

FIG. 8 is a front perspective view of the mower of FIG. 1 with the front cutting unit of FIG. 4 removed and the motor of FIG. 4 hanging freely.

FIG. 9 is a front perspective view of the motor of FIG. 4 and the lift arm of FIG. 5 being assembled into the service configuration.

FIG. 10 is a front perspective view of the motor of FIG. 4 and the lift arm of FIG. 5 assembled into the service configuration.

FIG. 11 is a right side view of the motor of FIG. 4 and the lift arm of FIG. 5 assembled into the service configuration.

FIG. 12A is a front perspective view of a rear cutting unit of the mower of FIG. 1.

FIG. 12B is a rear perspective view of a lift arm and a motor for use with the rear cutting unit of FIG. 12A.

FIG. 13 is a front perspective view of a motor coupled to a central cutting unit of the mower of FIG. 1.

FIG. 14 is a rear perspective view of a mounting bracket for the motor of FIG. 13.

FIG. 15 is a rear perspective view of the motor of FIG. 13 and the mounting bracket of FIG. 14 being assembled into the service configuration.

FIG. 16 is a top perspective view of the motor of FIG. 13 and the mounting bracket of FIG. 14 assembled into the service configuration.

FIG. 17 is a bottom perspective view of the motor of FIG. 13 and the mounting bracket of FIG. 14 assembled into the service configuration.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

According to an exemplary embodiment, a mower of the present disclosure includes a series of mower decks, each driven by a motor. When transporting the mower or servicing the mower, it may be advantageous to remove the mower decks (e.g., to provide clearance around certain components). However, after the mower decks are removed, the motors remain coupled to the chassis of the mower. If left hanging freely from the cables, the motors would be susceptible to damage. Instead, the mower of the exemplary embodiment includes a series of mounting brackets, to which the motors are attached. This limits the movement of the motors, preventing the cables from becoming tangled or other damage to the motors. Some of the mounting brackets are built into lift arms for the mower decks, and another mounting bracket is fixed to the chassis. Each of the mounting brackets permits the same fasteners that secured the motors to the mower decks to also be used to secure the motors to the mounting brackets.

### Overall Vehicle

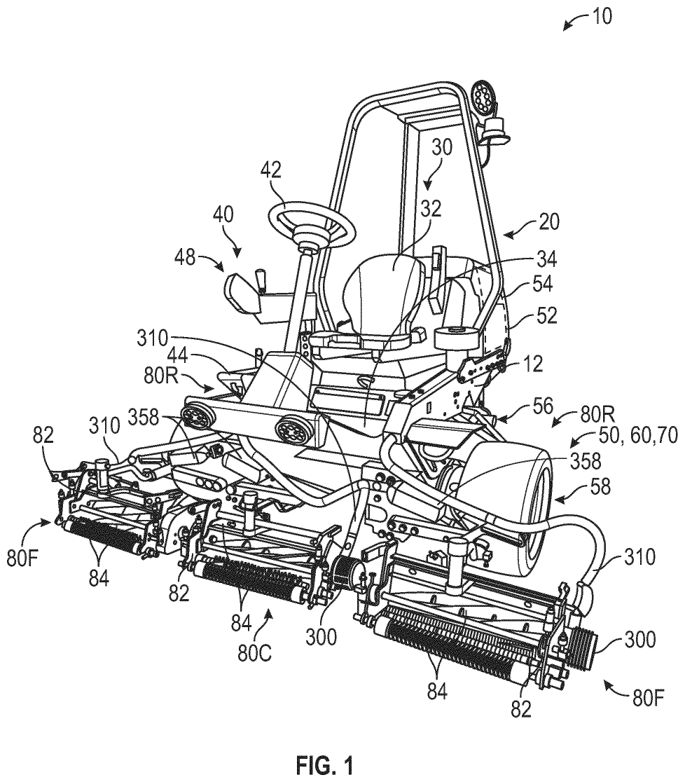

As shown in FIGS. 1-3, a machine or vehicle, shown as mower 10, includes a chassis, shown as frame 12; a body assembly, shown as body 20, coupled to the frame 12 and having an occupant portion or section, shown as occupant seating area 30; operator input and output devices, shown as operator controls 40, that are disposed within the occupant seating area 30; a drivetrain, shown as driveline 50, coupled to the frame 12 and at least partially disposed under the body 20; a vehicle suspension system, shown as suspension system 60, coupled to the frame 12 and one or more components of the driveline 50; a vehicle braking system, shown as braking system 70, coupled to one or more components of the driveline 50 to facilitate selectively braking the one or more components of the driveline 50; and a vehicle control system, shown as control system 100, coupled to the operator controls 40, the driveline 50, the suspension system 60, the braking system 70, and/or one or more external devices or systems positioned remote from the mower 10, shown as remote system(s) 200. The mower 10 further includes a series of implements, mower assemblies, or cutting units, shown as mower decks 80. In other embodiments, the mower 10 includes more or fewer components.

According to an exemplary embodiment, the mower 10 is an off-road machine or vehicle. In some embodiments, the mower 10 is a lawnmower, a turf mower, a push mower, a ride-on mower, a stand-on mower, or another type of mower. In other embodiments, the off-road machine or vehicle is a lightweight or recreational machine or vehicle such as a golf cart, an all-terrain vehicle (“ATV”), a utility task vehicle (“UTV”), and/or another type of lightweight or recreational machine or vehicle. In some embodiments, the off-road machine or vehicle is a chore product such as aerator, turf sprayer, bunker rake, and/or another type of chore product (e.g., that may be used on a golf course).

According to the exemplary embodiment shown in FIG. 1, the occupant seating area 30 includes a single seat, shown as driver seat 32. In some embodiments, the occupant seating area 30 includes additional seats (e.g., a passenger seat, an additional row of seats, etc.). According to the exemplary embodiment shown in FIG. 1, the driver seat 32 is laterally centered on the body 20 and facing forward. In some embodiments, the driver seat 32 is facing rearward or otherwise positioned. In some embodiments, the occupant seating area 30 is omitted (e.g., the mower 10 is configured as a push mower). A portion of the frame 12 defines a platform, deck, or standing area, shown as operator platform 34. The operator platform 34 may extend forward of the driver seat 32 such that the occupant can rest their feet on the operator platform 34 while seated in the driver seat 32. The operator platform 34 may support the occupant as the occupant enters or exits the driver seat 32.

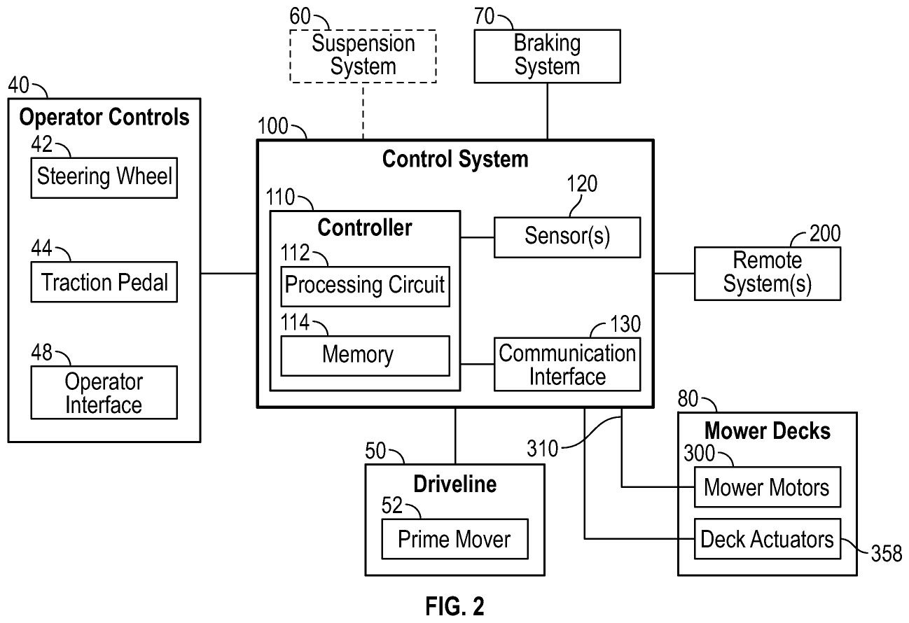

According to an exemplary embodiment, the operator controls 40 are configured to provide an operator with the ability to control one or more functions of and/or provide commands to the mower 10 and the components thereof (e.g., turn on, turn off, drive, turn, brake, engage various operating modes, raise/lower a mower deck 80, etc.). As shown in FIGS. 1 and 2, the operator controls 40 include a steering interface (e.g., a steering wheel, joystick(s), etc.), shown steering wheel 42, an accelerator interface and/or braking interface (e.g., a pedal, a throttle, etc.), shown as traction pedal 44, and one or more additional interfaces, shown as operator interface 48. The traction pedal 44 may be used to control the speed and direction of travel of the mower 10. By way of example, pressing the traction pedal 44 in a first direction may cause the driveline 50 to move the mower 10 forward, and pressing the traction pedal 44 in an opposing section direction may cause the driveline 50 to move the mower 10 rearward. Returning the traction pedal 44 to a middle or neutral position may cause the braking system 70 and/or the driveline 50 to slow or stop the mower 10 or to hold the mower 10 in place. Alternatively, the operator interface 48 may include a pair of handles that control the driveline 50 in a zero-turn configuration (e.g., a left joystick to control the left side of the driveline 50 and a right joystick to control a right side of the driveline 50). The operator interface 48 may be used to control operation of the mower decks 80 (e.g., changing a cutting speed of a mower deck 80, changing a cutting height of a mower deck 80, etc.). The operator interface 48 may include one or more displays and one or more input devices. The one or more displays may be or include a touchscreen, an LCD display, a LED display, a speedometer, gauges, warning lights, etc. The one or more input device may be or include buttons, switches, knobs, levers, dials, etc.

According to an exemplary embodiment, the driveline 50 is configured to propel the mower 10. As shown in FIGS. 1 and 2, the driveline 50 includes a primary driver, shown as prime mover 52, an energy storage device, shown as energy storage 54, a first tractive assembly (e.g., axles, wheels, tracks, differentials, etc.), shown as rear tractive assembly 56, and a second tractive assembly (e.g., axles, wheels, tracks, differentials, etc.), shown as front tractive assembly 58. In some embodiments, the driveline 50 is a conventional driveline whereby the prime mover 52 is an internal combustion engine and the energy storage 54 is a fuel tank. The internal combustion engine may be a spark-ignition internal combustion engine or a compression-ignition internal combustion engine that may use any suitable fuel type (e.g., diesel, ethanol, gasoline, natural gas, propane, etc.). In some embodiments, the driveline 50 is an electric driveline whereby the prime mover 52 is one or more electric motors and the energy storage 54 is a battery system. In some embodiments, the driveline 50 is a fuel cell electric driveline whereby the prime mover 52 is one or more electric motors and the energy storage 54 is a fuel cell (e.g., that stores hydrogen, that produces electricity from the hydrogen, etc.). In some embodiments, the driveline 50 is a hybrid driveline whereby (i) the prime mover 52 includes an internal combustion engine and an electric motor/generator and (ii) the energy storage 54 includes a fuel tank and/or a battery system. According to the exemplary embodiment shown in FIG. 1, the rear tractive assembly 56 includes rear tractive elements and the front tractive assembly 58 includes front tractive elements that are configured as wheels. In some embodiments, the rear tractive elements and/or the front tractive elements are configured as tracks. In some embodiments, the driveline 50 is omitted, and the mower 10 is propelled by an operator (e.g., the mower 10 is configured as a push mower).

According to an exemplary embodiment, the prime mover 52 is configured to provide power to drive the rear tractive assembly 56 and/or the front tractive assembly 58 (e.g., to provide front-wheel drive, rear-wheel drive, four-wheel drive, and/or all-wheel drive operations). In some embodiments, the driveline 50 includes a transmission device (e.g., a gearbox, a continuous variable transmission (“CVT”), etc.) positioned between (a) the prime mover 52 and (b) the rear tractive assembly 56 and/or the front tractive assembly 58. The rear tractive assembly 56 and/or the front tractive assembly 58 may include a drive shaft, a differential, and/or an axle. In some embodiments, the rear tractive assembly 56 and/or the front tractive assembly 58 include two axles or a tandem axle arrangement. In some embodiments, the rear tractive assembly 56 and/or the front tractive assembly 58 are steerable (e.g., using the steering wheel 42). In some embodiments, both the rear tractive assembly 56 and the front tractive assembly 58 are fixed and not steerable (e.g., employ skid steer operations). By way of example, the driveline 50 may include a hydrostatic transmission that permits independent driving of the left and right sides of the driveline 50.

In some embodiments, the driveline 50 includes a plurality of prime movers 52. By way of example, the driveline 50 may include a first prime mover 52 that drives the rear tractive assembly 56 and a second prime mover 52 that drives the front tractive assembly 58. By way of another example, the driveline 50 may include a first prime mover 52 that drives a first one of the front tractive elements, a second prime mover 52 that drives a second one of the front tractive elements, a third prime mover 52 that drives a first one of the rear tractive elements, and/or a fourth prime mover 52 that drives a second one of the rear tractive elements. By way of still another example, the driveline 50 may include a first prime mover 52 that drives the front tractive assembly 58, a second prime mover 52 that drives a first one of the rear tractive elements, and a third prime mover 52 that drives a second one of the rear tractive elements. By way of yet another example, the driveline 50 may include a first prime mover 52 that drives the rear tractive assembly 56, a second prime mover 52 that drives a first one of the front tractive elements, and a third prime mover 52 that drives a second one of the front tractive elements.

According to an exemplary embodiment, the suspension system 60 includes one or more suspension components (e.g., shocks, dampers, springs, etc.) positioned between the frame 12 and one or more components (e.g., tractive elements, axles, etc.) of the rear tractive assembly 56 and/or the front tractive assembly 58. In some embodiments, the mower 10 does not include the suspension system 60.

According to an exemplary embodiment, the braking system 70 includes one or more braking components (e.g., disc brakes, drum brakes, in-board brakes, axle brakes, etc.) positioned to facilitate selectively braking one or more components of the driveline 50. In some embodiments, the one or more braking components include (i) one or more front braking components positioned to facilitate braking one or more components of the front tractive assembly 58 (e.g., the front axle, the front tractive elements, etc.) and (ii) one or more rear braking components positioned to facilitate braking one or more components of the rear tractive assembly 56 (e.g., the rear axle, the rear tractive elements, etc.). In some embodiments, the one or more braking components include only the one or more front braking components. In some embodiments, the one or more braking components include only the one or more rear braking components. In some embodiments, the one or more front braking components include two front braking components, one positioned to facilitate braking each of the front tractive elements. In some embodiments, the one or more rear braking components include two rear braking components, one positioned to facilitate braking each of the rear tractive elements. In some embodiments, the driveline 50 is a hydrostatic transmission that performs braking by using hydraulic motors to oppose movement of the tractive elements.

As shown in FIG. 2, the control system 100 includes a controller 110, one or more sensors 120, and a communications interface 130 (e.g., located on the mower 10). In some embodiments, the control system includes the remote systems(s) 200. In one embodiment, the controller 110 is configured to selectively engage, selectively disengage, control, or otherwise communicate with components of the mower 10. According to an exemplary embodiment, the controller 110 is coupled to (e.g., communicably coupled to) components of the operator controls 40 (e.g., the steering wheel 42, the traction pedal 44, the operator interface 48, etc.), components of the driveline 50 (e.g., the prime mover 52), components of the braking system 70, the sensors 120, the communications interface 130, and the remote system(s) 200. By way of example, the controller 110 may send and receive signals (e.g., control signals, location signals, etc.) with the components of the operator controls 40, the components of the driveline 50, the components of the braking system 70, the sensors 120, the communications interface 130, and/or the remote system(s) 200.

The controller 110 may be implemented as a general-purpose processor, an application specific integrated circuit (“ASIC”), one or more field programmable gate arrays (“FPGAs”), a digital-signal-processor (“DSP”), circuits containing one or more processing components, circuitry for supporting a microprocessor, a group of processing components, or other suitable electronic processing components. According to the exemplary embodiment shown in FIG. 2, the controller 110 includes a processing circuit 112 and a memory 114. The processing circuit 112 may include an ASIC, one or more FPGAs, a DSP, circuits containing one or more processing components, circuitry for supporting a microprocessor, a group of processing components, or other suitable electronic processing components. In some embodiments, the processing circuit 112 is configured to execute computer code stored in the memory 114 to facilitate the activities described herein. The memory 114 may be any volatile or non-volatile or non-transitory computer-readable storage medium capable of storing data or computer code relating to the activities described herein. According to an exemplary embodiment, the memory 114 includes computer code modules (e.g., executable code, object code, source code, script code, machine code, etc.) configured for execution by the processing circuit 112. In some embodiments, the controller 110 may represent a collection of processing devices. In such cases, the processing circuit 112 represents the collective processors of the devices, and the memory 114 represents the collective storage devices of the devices.

The sensors 120 may include various sensors positioned about the mower 10 to acquire information or data regarding operation of the mower 10 and/or the location thereof. By way of example, the sensors 120 may include an accelerometer, a gyroscope, a compass, a position sensor (e.g., a GPS sensor, etc.), suspension sensor(s), wheel sensors, an audio sensor or microphone, and/or other sensors to facilitate acquiring information or data regarding operation of the mower 10 and/or the location thereof. According to an exemplary embodiment, one or more of the sensors 120 are configured to facilitate detecting and obtaining vehicle telemetry data including position of the mower 10, whether the mower 10 is moving, travel direction of the mower 10, slope of the mower 10, speed of the mower 10, vibrations experienced by the mower 10, sounds proximate the mower 10, suspension travel of components of the suspension system 60, and/or other vehicle telemetry data.

The communications interface 130 may be configured to facilitate wireless communications with the remote system(s) 200. By way of example, the communications interface 130 may be configured to employ one or more types of wireless communications protocols including Bluetooth, Wi-Fi, radio, cellular, and/or other suitable wireless communications protocols.

The remote systems 200 may be or include an off-site server-based system that monitors various global positioning system (“GPS”) information and/or real-time kinematics (“RTK”) information (e.g., position/location, speed, direction of travel, geofence related information, etc.) and provides GPS data and/or RTK data based on the GPS information and/or RTK information to the controller 110 of the mower 10 through the communications interface 130. The remote systems 200 may additionally or alternatively be or include an on-site system (e.g., in a club house of a golf course, on the golf course, etc.) that communicates with the mower 10 via the communications interface 130. The on-site system may collect data from the mower 10 that may be used by the operators of the site (e.g., for advanced scheduling purposes, to identify persons braking course guidelines or rules, etc.). The on-site system may also function as an intermediary between the mower 10 and the off-site server-based system (e.g., if the communications interface 130 does not have long-range wireless communications capabilities). In some embodiments, the remote system(s) 200 include a processing circuit, a memory, and a communications interface similar to the control system 100. In some embodiments (e.g., when the remote system(s) 200 are part of the control system 100), the control system 100 includes a plurality of processing circuits 112 (e.g., a first processing circuit for the controller 110 of the mower 10 and a second processing circuit for the remote system(s) 200) and a plurality of memories 114 (e.g., a first memory for the controller 110 of the mower 10 and a second memory for the remote system(s) 200).

### Mower Deck Arrangement

Referring to FIG. 1, the mower 10 includes a series of mower decks 80, referred to generally herein as mower decks 80. The mower decks 80 include a pair of front mower decks, shown as mower decks 80F, a pair of rear mower decks, shown as mower decks 80R, and a central mower deck, shown as mower deck 80C. The mower decks 80F are arranged symmetrically about a longitudinal centerline of the frame 12 such that one mower deck 80F is positioned on a right side of the mower 10, and another mower deck 80F is positioned on left side of the mower 10. The mower deck 80C is positioned along the longitudinal centerline, between the mower decks 80F. The mower decks 80R are positioned rearward of the mower decks 80F and the mower deck 80C. The mower decks 80R are arranged symmetrically about the longitudinal centerline such that one mower deck 80R is positioned on a right side of the mower 10, and another mower deck 80R is positioned on left side of the mower 10.

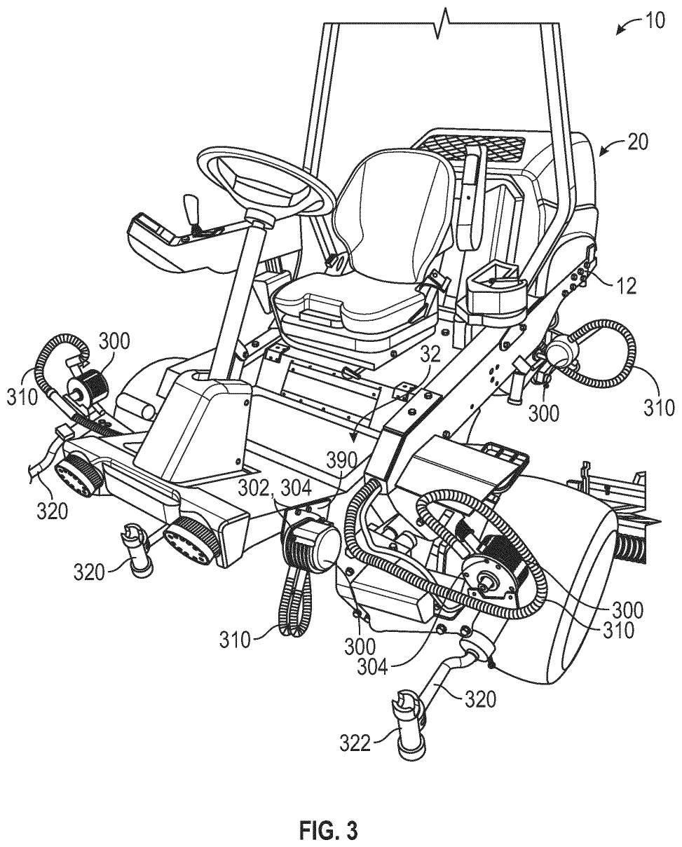

The mower 10 is selectively reconfigurable between (a) an operating, operational, or use configuration, shown in FIG. 1 and (b) a maintenance, service, or transport configuration, shown in FIG. 3. In the operating configuration, the mower decks 80 are coupled to the frame 12 and configured for use (e.g., cutting vegetation). In the service configuration, one or more of the mower decks 80 may be removed from the frame 12. The service configuration may increase the ground clearance of the mower 10, permitting the mower 10 to navigate onto surfaces that might otherwise contact the mower decks 80 (e.g., when driving up a ramp, when driving onto a trailer, etc.). Accordingly, the service configuration may facilitate shipping or transportation of the mower 10. The removal of the mower decks 80 in the service configuration may facilitate access to components and areas of the mower that might otherwise be obstructed by the mower decks 80. Accordingly, the service configuration may facilitate performing maintenance or service procedures (e.g., cleaning, replacement of components, changing of fluids, etc.).

In some embodiments, the mower 10 is configurable into multiple different service configurations. By way of example, in a full or complete service configuration, all of the mower decks 80 may be removed from the frame 12. By way of example, in a partial service configuration a first subset of the mower decks 80 may be removed from the frame 12 while a second subset of the mower decks 80 remain coupled to the frame 12. A partial service configuration may be used, for example, when maintenance personnel require access to an area that is only obstructed by the first subset of the mower decks 80.

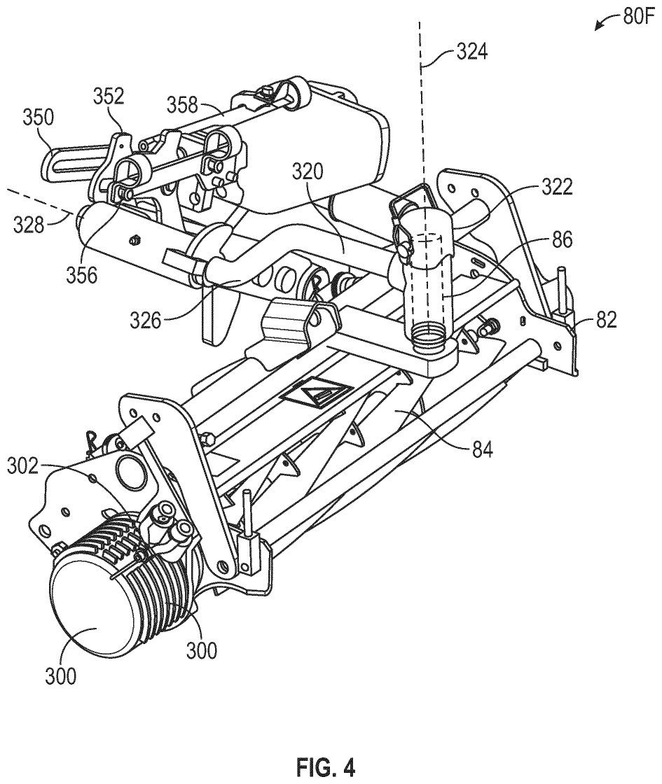

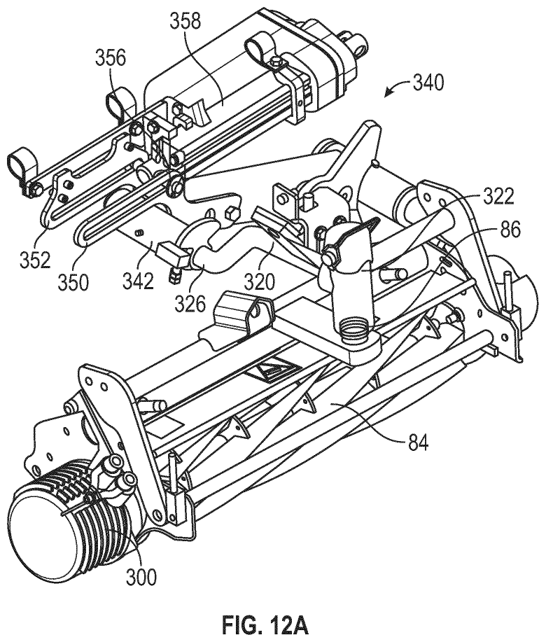

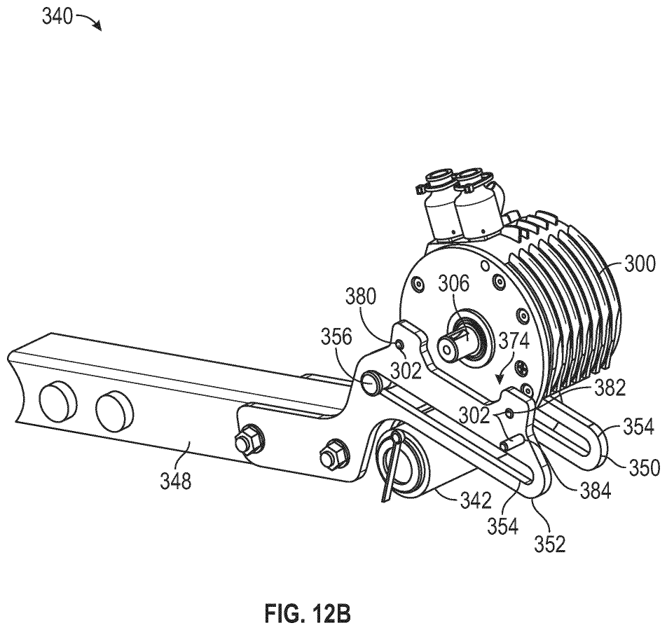

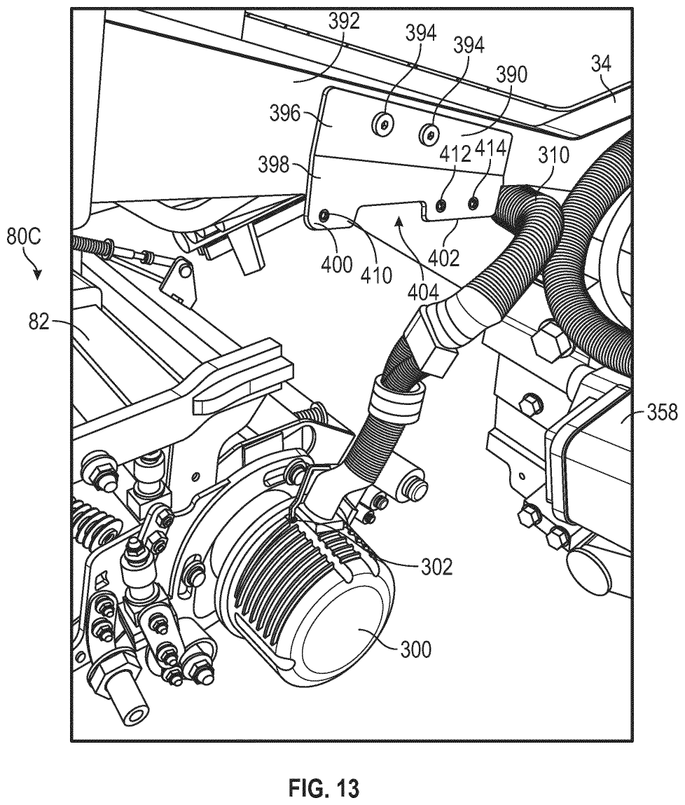

Referring to FIGS. 1 and 4, the construction of a mower deck 80F is shown according to an exemplary embodiment. The mower decks 80R and 80C may have a similar configuration to the mower deck 80F, as shown in FIGS. 12A and 13. Each mower deck 80 includes a base, deck, housing, frame, or enclosure, shown as housing 82, and series of cutting elements 84 (e.g., reels, blades, flails, etc.) movably coupled to the housing 82. The housing 82 may provide the structure to support the other components of the mower deck 80. The housing 82 may open downward to expose the cutting elements 84 to vegetation below the housing 82. Each mower deck 80 includes an interface, shown as post 86, that extends upward from the housing 82. The post 86 may be fixedly coupled to the housing 82 and facilitate coupling the housing 82 to the frame 12.

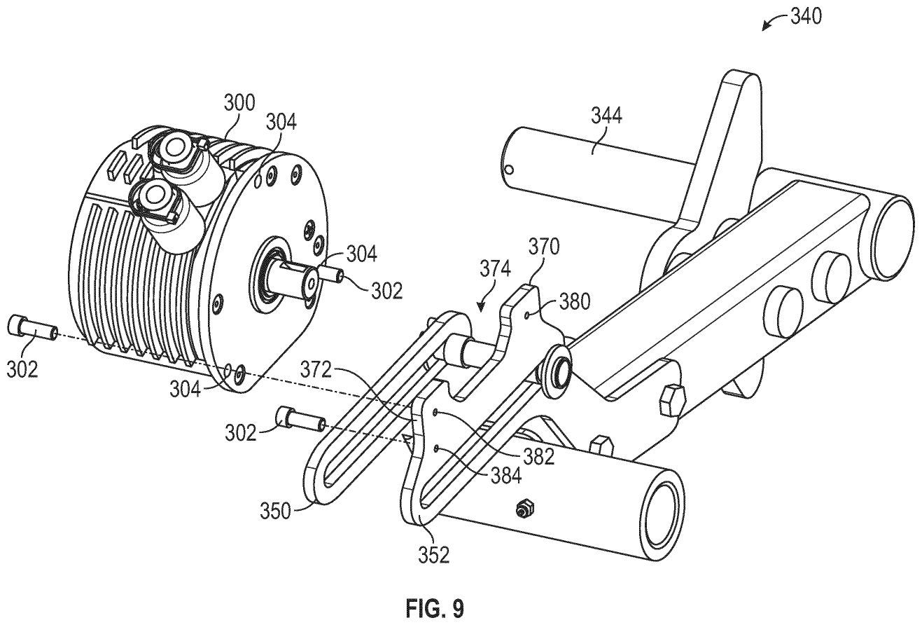

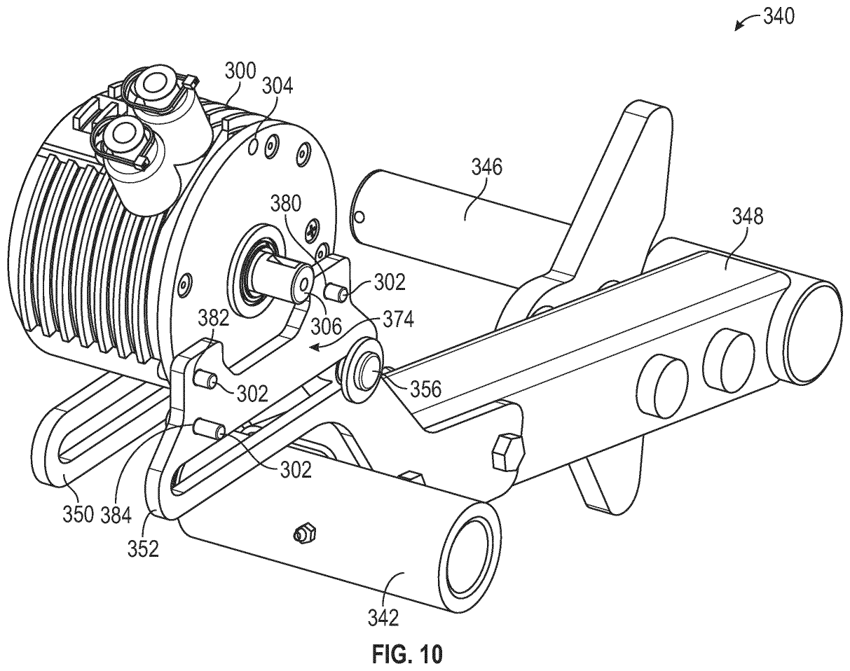

Each mower deck 80 is coupled to a motor or actuator (e.g., an electric motor, a hydraulic motor, etc.), shown as mower motor 300. Specifically, each mower motor 300 is removably coupled to the housing 82 of the corresponding mower deck 80 by a series of fasteners, shown as mounting bolts 302. The mower motor 300 defines three apertures or passages (e.g., as shown in FIG. 9), shown as fastener apertures 304, through which the mounting bolts 302 extend. The fastener apertures 304 may be evenly spaced along the circumference of the mower motor 300. The mounting bolts 302 may be in threaded engagement with the housing 82 to fixedly couple the mower motor 300 to the housing 82. Additionally or alternatively, the mounting bolts 302 may be in threaded engagement with a secondary fastener, such as a nut, that secures the mower motor 300 to the housing 82. The mower motor 300 may provide rotational mechanical energy (e.g., through an output shaft or motor shaft 306, as shown in FIG. 10) to drive movement (e.g., rotation, oscillation, etc.) of the cutting elements 84. While driven by the mower motor 300, the cutting elements 84 cut, crush, mulch, remove, or otherwise trim vegetation beneath the housing 82. Operation of the mower motor 300 may be controlled by the control system 100.

Each mower motor 300 is operatively coupled to the energy storage 54 and/or the control system 100 by a flexible member or tensile member (e.g., a wire, cable, or hose), shown as cable 310. The cables 310 may transfer energy (e.g., in the form of electrical energy or pressurized hydraulic fluid, etc.) to the mower motors 300 to power operation of the mower motors 300. A first end portion of each cable 310 may be coupled to the mower motor 300, and an opposing second end portion of each cable 310 may be coupled to the frame 12. The cables 310 may be flexible to permit movement of the mower decks 80 relative to the chassis 12.

Each mower deck 80 is coupled to the frame 12 by a connecting shaft 320. A first end portion or interface of the connecting shaft 320, shown as receiver 322, receives the post 86 of the mower deck 80, pivotally coupling the mower deck 80 to the connecting shaft 320. The receiver 322 defines a recess or passage that receives the post 86, permitting rotation of the mower deck 80 relative to the connecting shaft 320 about a substantially vertical axis 324 that is centered about the post 86. A second end portion or interface of the connecting shaft 320, shown as shaft end 326, extends away from the receiver 322 and is centered about a longitudinal axis 328.

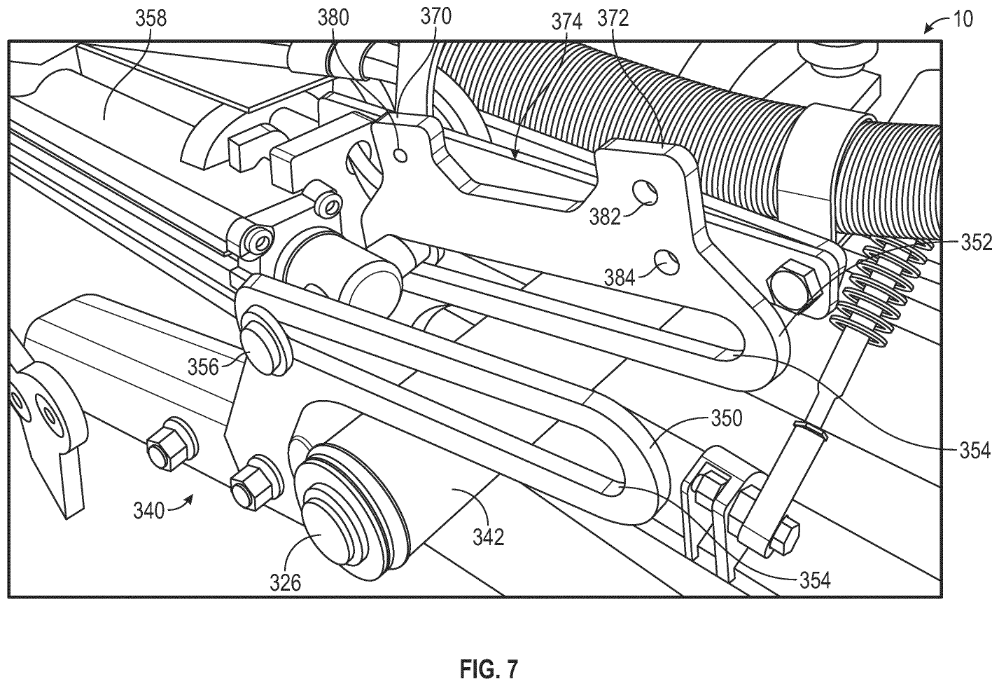

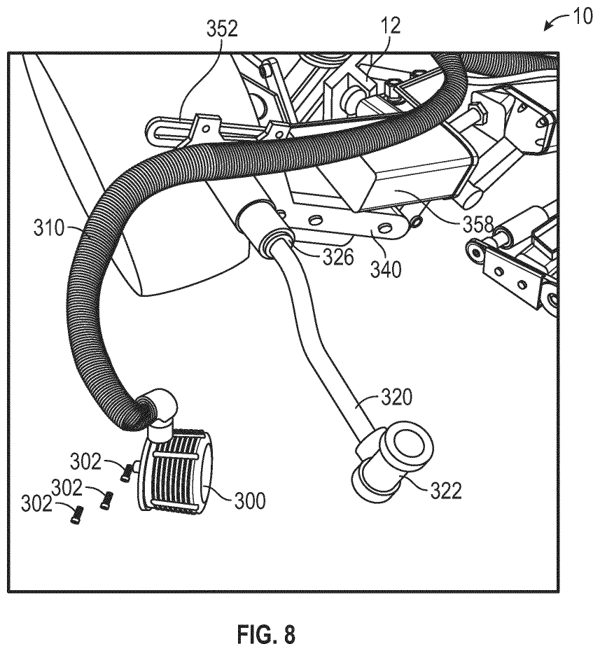

Referring to FIGS. 4-8, each connecting shaft 320 is coupled to the frame 12 by a lift arm 340. A first end portion or interface of the lift arm 340, shown as receiver 342, defines a passage that extends along the longitudinal axis 328 and receives the shaft end 326 of the connecting shaft 320, pivotally coupling the connecting shaft 320 to the lift arm 340. The receiver 342 permits rotation of the connecting shaft 320 relative to the lift arm 340 about the longitudinal axis 328. A second end portion or interface of the connecting shaft 320, shown as lift arm shaft 344, extends along and is centered about a longitudinal axis 346 that is offset from the longitudinal axis 328. The lift arm shaft 344 is received by the frame 12, pivotally coupling the lift arm 340 to the frame 12. Accordingly, the lift arm 340 is rotatable relative to the frame 12 about the longitudinal axis 346. A main portion of the lift arm 340, shown as lift arm body 348, extends between the receiver 342 and the lift arm shaft 344.

The lift arm 340 includes a pair of mounting brackets or plates, shown as float plate 350 and float plate 352, fixedly coupled to the lift arm body 348. The lift arm body 348 extends between the float plate 350 and the float plate 352, offsetting the float plates 350 and 352 such that the float plates 350 and 352 are positioned on opposite sides of the lift arm body 348. The float plate 350 and the float plate 352 each define a slot or passage, shown as pin slot 354, that extends along a length of the lift arm 340. The pin slots 354 are aligned with one another. A pin or shaft, shown as float pin 356, extends longitudinally through the pin slots 354.

A linear actuator or lift actuator, shown as deck actuator 358, has a first end coupled to the float pin 356 and a second end pivotally coupled to the frame 12. The deck actuator 358 may extend or retract to vary a distance between the float pin 356 and the frame 12. By way of example, the deck actuator 358 may include an electric linear actuator or a hydraulic cylinder. As shown in FIG. 2, the deck actuator 358 may be operatively coupled to the controller 110. In other embodiments, the deck actuator 358 is another type of actuator, such as a lever that is manually operated by a user or a power take off from a prime mover (e.g., an engine, an electric motor, etc.) of the mower 10 (e.g., connected to the mower deck 80 by one or more belts).

A user may set a target height of the mower deck 80 (e.g., with the operator interface 48). By way of example, the user may set the mower deck 80 to a relatively low cutting height to permit trimming vegetation. By way of another example, the use may set the mower deck 80 to a relatively high travel height to permit travel at elevated speeds without the mower deck 80 contacting the ground. The controller 110 may operate the deck actuator 358 to bring the corresponding mower deck 80 to the target height.

When the deck actuator 358 retracts, the float pin 356 contacts the proximal ends of the pin slots 354, rotating the lift arm 340 upward. This upward rotation of the lift arm 340 raises the connecting shaft 320 and the mower deck 80. Because the connecting shaft 320 is pivotable relative to the lift arm 340, gravity acting on mower deck 80 may level the mower deck after this action. When the deck actuator 358 extends, the float pin 356 moves away from the frame 12, and the lift arm is permitted to rotate downward. This downward rotation of the lift arm 340 lowers the connecting shaft 320 and the mower deck 80. Because the connecting shaft 320 is pivotable relative to the lift arm 340, gravity acting on mower deck 80 may level the mower deck after this action.

When the mower deck 80 encounters a ground surface having an upward change in elevation (e.g., a bump or hill), the ground surface may force the mower deck 80 upward. The arrangement of the lift arm 340 may permit the mower deck 80 to float freely upward to accommodate this upward force. Specifically, the lengths of the pin slots 354 may permit free movement of the float pin 356. When the upward force is applied, the float pin 356 moves freely toward the distal ends of the pin slots 354, permitting the mower deck 80 to move upward. When the upward force is reduced (e.g., the ground surface has a decrease in elevation), gravity draws the mower deck 80 downward and the float pin 356 moves back toward the proximal ends of the pin slots 354.

Referring to FIGS. 3, 10, and 11, the lift arms 340 corresponding to the mower decks 80F and 80R are each configured to removably and fixedly couple to a corresponding mower motor 300 to support the mower motor 300 when the mower 10 is in the service configuration. When fixed to the lift arm 340, the mower motor 300 moves with the lift arm 340 relative to the chassis, and the corresponding cable 310 loops back toward the frame 12.

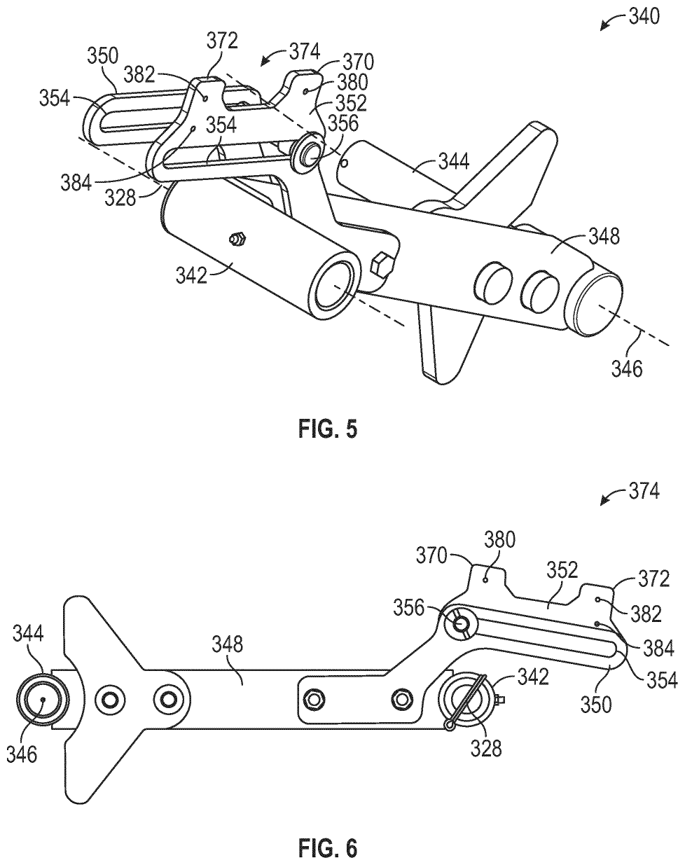

As shown in FIGS. 5-7, 9, and 10, the float plate 352 includes a pair of vertical protrusions or motor mounting features, shown as tab 370 and tab 372. The tabs 370 and 372 extend upward, above the pin slot 354. As shown, the float plate 350 omits the tabs 370 and 372, such that the float plate 352 extends further in an upward direction than (i.e., higher than) the float plate 350. The tabs 370 and 372 are laterally offset by one another to form a gap, opening, recess, or space, shown as motor shaft recess 374.

The tab 370 defines a first longitudinal passage or aperture, shown as fastener passage 380. The tab 372 defines a second longitudinal passage or aperture, shown as fastener passage 382, and a third longitudinal passage or aperture, shown as fastener passage 384. The fastener passages 380 and 382 are positioned approximately the same distance from the pin slot 354 of the float plate 352. The fastener passage 384 is positioned between the fastener passage 382 and the pin slot 354, such that a distance from the pin slot 354 to the fastener passage 382 is greater than a distance from the pin slot 354 to the fastener passage 384.

Each of the fastener passages 380, 382, and 384 defines a female thread that is sized to threadedly engage a corresponding male thread of one of the mounting bolts 302. As shown in FIGS. 9 and 10, the mower motor 300 may be coupled to the float plate 352 by the mounting bolts 302. A first distance between the fastener passage 380 and the fastener passage 382 may be approximately equal to a second distance between two of the fastener apertures 304, such that the fastener passage 380 and the fastener passage 382 may each align with one of the fastener apertures 304. In some embodiments, the fastener apertures 304 are uniformly spaced along the circumference of the mower motor 300, such that the fastener passages 380 and 382 may be aligned with any two of the fastener apertures 304.

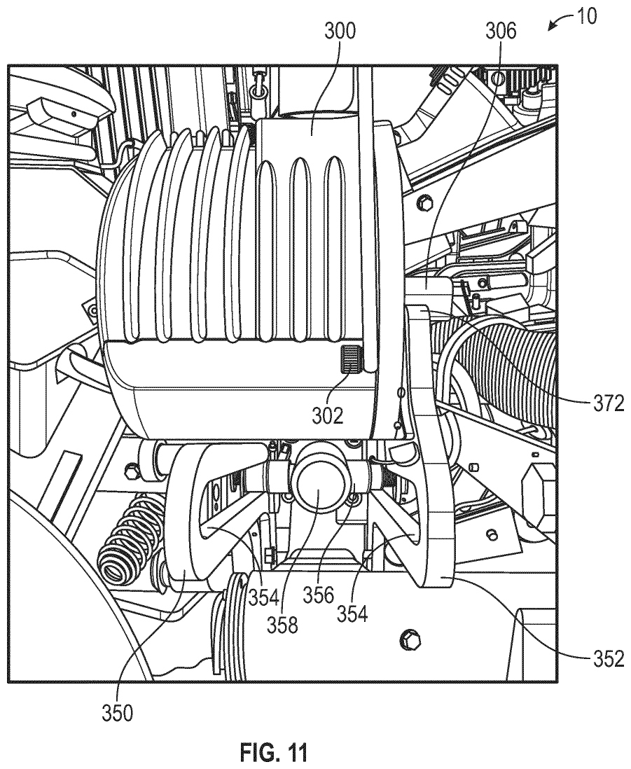

To couple the mower motor 300 to the float plate 352, a first mounting bolt 302 is inserted through one of the fastener apertures 304 and placed in threaded engagement with the fastener passage 380. A second mounting bolt 302 is inserted through another of the fastener apertures 304 and placed in threaded engagement with the fastener passage 382. When both mounting bolts 302 have been tightened, the mower motor 300 is fixed to the float plate 352. Additionally, the motor shaft 306 extends through the motor shaft recess 374, such that the motor shaft recess 374 provides clearance for the motor shaft 306. As shown in FIG. 11, a body of the mower motor 300 extends rearward from the float plate 352 and overhangs the float plate 350. Accordingly, the float plate 350 being shorter than the float plate 352 provides clearance for the mower motor 300 to overhang the float plate 350. In some embodiments, the mower motor 300 rests atop the float plate 350 to provide additional support to the mower motor 300.

While more than two mounting bolts 302 may not be necessary to secure the mower motor 300 to the float plate 352 in the service configuration, the mower 10 may utilize three or more mounting bolts 302 (e.g., three mounting bolts 302 as shown in various figures herein) to couple the mower motor 300 to the housing 82 in the operating configuration. Accordingly, it may be desirable to secure these additional mounting bolts 302 to the lift arm 340 (e.g., so the mounting bolts 302 all remain with the mower 10 and are not lost). To facilitate this, the third mounting bolt 302 may be threaded into the fastener passage 384 and tightened, securing the mounting bolt 302 to the float plate 352.

FIGS. 12A and 12B illustrate a mower deck 80R and a lift arm 340 for use with the mower deck 80R. The arrangement of the mower deck 80R and corresponding lift arm 340 may be substantially similar to that of FIG. 4 except as otherwise specified. The lift arms 340 that support the mower decks 80R are arranged with the float plates 350 and 352 inverted. By way of example, the float plate 352 supporting the mower deck 80F in FIG. 4 is arranged forward of the corresponding float plate 350, whereas the float plate 352 supporting the mower deck 80R in FIG. 12A is arranged rearward of the corresponding float plate 350. The mower motors 300 overhang the float plates 350, such that this inverted arrangement of the float plates 350 and 352 also inverts the orientations of the mower motors 300 in the service configuration. By way of example, the body of the mower motor 300 for the mower deck 80F extends rearward from the float plate 352 (as shown in FIG. 10), and the body of the mower motor 300 for the mower deck 80R extends rearward from the float plate 352 (as shown in FIG. 12B).

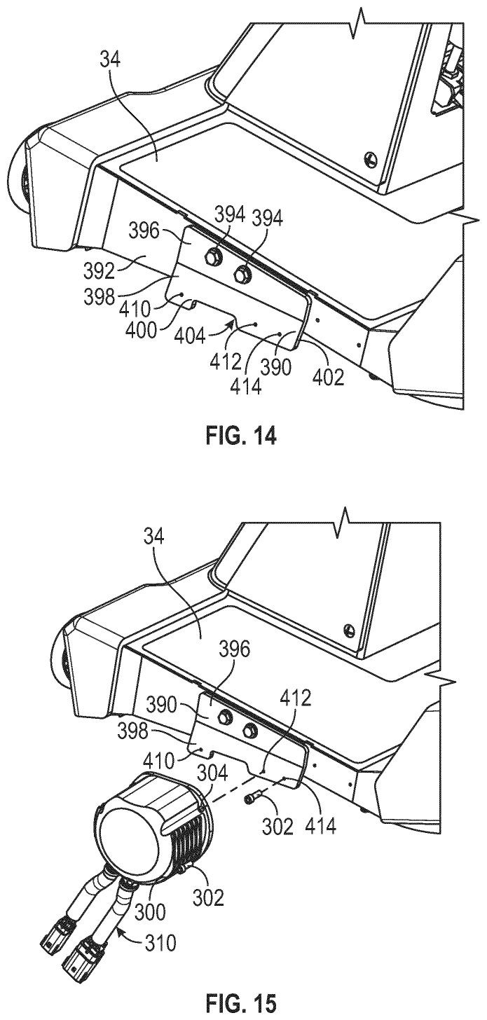

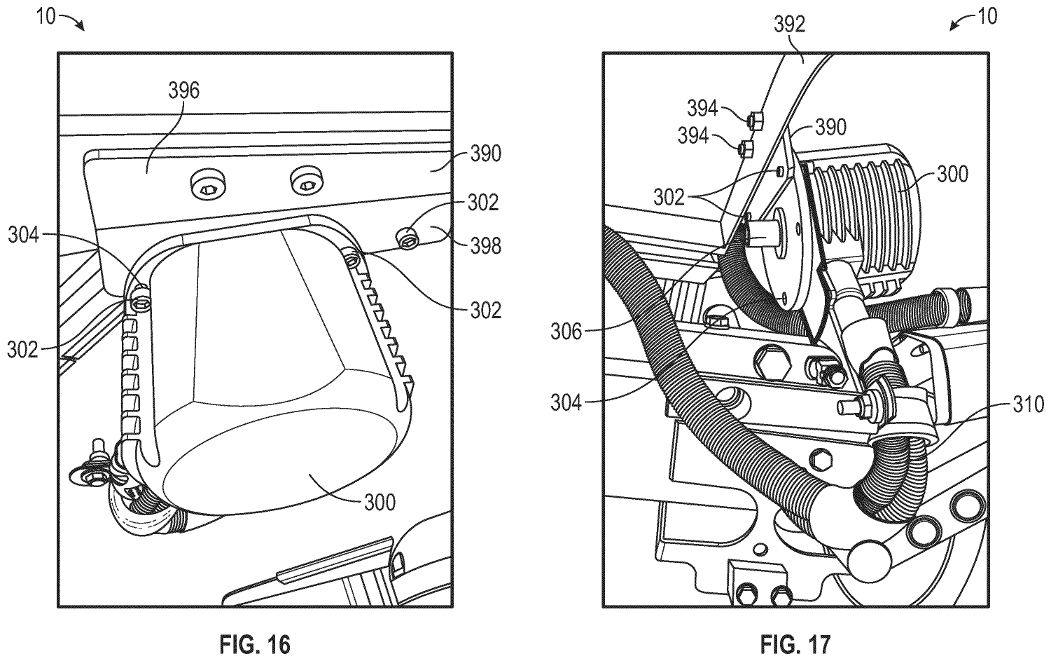

Referring to FIGS. 13-17, the mower 10 includes a mounting bracket or motor mount, shown as mounting plate 390, that is fixedly coupled to the frame 12. The mounting plate 390 is configured to removably and fixedly couple to the mower motor 300 corresponding to the mower deck 80C to support the mower motor 300 when the mower 10 is in the service configuration. When fixed to the mounting plate 390, the mower motor 300 is fixed to the frame 12, and the corresponding cable 310 extends away from the loops back toward the frame 12. The mounting plate 390 may be used instead of directly mounting the mower motor 300 of the mower deck 80C to the corresponding float plate 352 for clearance or accessibility. In other embodiments, the mower motor 300 of the mower deck 80C is directly coupled to the corresponding float plate 352, and/or the mounting plate 390 is omitted.

The operator platform 34 includes a flange or plate, shown as flange 392, that is fixedly coupled to the rest of the operator platform and extends below the rest of the operator platform 34. The flange 392 extends vertically and longitudinally. The flange 392 is positioned along a left side of the operator platform 34 and extends downward from the top portion of the operator platform 34. The flange 392 extends longitudinally along the operator platform. A pair of fasteners, shown as bolts 394, fixedly couple the mounting plate 390 to the flange 392. When coupled to the flange 392, the mounting plate 390 extends below the flange 392.

The mounting plate 390 includes a pair of vertical protrusions or motor mounting features, shown as tab 400 and tab 402. The tabs 400 and 402 extend downward, below the flange 392 and the operator platform 34. The tabs 400 and 402 are longitudinally offset from one another to form a gap, opening, recess, or space, shown as motor shaft recess 404.

The tab 400 defines a first lateral passage or aperture, shown as fastener passage 410. The tab 402 defines a second lateral passage or aperture, shown as fastener passage 412, and a third lateral passage or aperture, shown as fastener passage 414. The fastener passages 410 and 412 are positioned approximately the same distance from the flange 392. The fastener passage 410, the fastener passage 412, and the fastener passage 414 are all positioned approximately along a longitudinal line (e.g., at approximately the same vertical position). The fastener passage 412 is positioned between the fastener passage 410 and the fastener passage 414, such that a distance from the fastener passage 410 to the fastener passage 412 is greater than a distance from the fastener passage 410 to the fastener passage 414.

Each of the fastener passages 410, 412, and 414 defines a female thread that is sized to threadedly engage a corresponding male thread of one of the mounting bolts 302. As shown in FIGS. 15-17, the mower motor 300 may be coupled to the mounting plate 390 by the mounting bolts 302. A first distance between the fastener passage 410 and the fastener passage 412 may be approximately equal to a second distance between two of the fastener apertures 304, such that the fastener passage 410 and the fastener passage 412 may each align with one of the fastener apertures 304. In some embodiments, the fastener apertures 304 are uniformly spaced along the circumference of the mower motor 300, such that the fastener passages 410 and 412 may be aligned with any two of the fastener apertures 304.

To couple the mower motor 300 to the mounting plate 390, a first mounting bolt 302 is inserted through one of the fastener apertures 304 and placed in threaded engagement with the fastener passage 410. A second mounting bolt 302 is inserted through another of the fastener apertures 304 and placed in threaded engagement with the fastener passage 412. When both mounting bolts 302 have been tightened, the mower motor 300 is fixed to the mounting plate 390, and thus fixed to the frame 12. Additionally, the motor shaft 306 extends through the motor shaft recess 404, such that the motor shaft recess 404 provides clearance for the motor shaft 306.

While more than two mounting bolts 302 may not be necessary to secure the mower motor 300 to the mounting plate 390 in the service configuration, the mower 10 may utilize three or more mounting bolts 302 (e.g., three mounting bolts 302 as shown in various figures herein) to couple the mower motor 300 to the housing 82 of the mower deck 80C in the operating configuration. Accordingly, it may be desirable to secure these additional mounting bolts 302 to the frame 12 (e.g., so the mounting bolts 302 all remain with the mower 10 and are not lost). To facilitate this, the third mounting bolt 302 may be threaded into the fastener passage 414 and tightened, securing the mounting bolt 302 to the mounting plate 390.

In some embodiments, some or all of the mounting bolts 302 may be the same size (e.g., length, diameter, and/or thread pitch), such that the mounting bolts 302 are interchangeable with one another. This may be desirable to reduce complexity and increase flexibility during the assembly process. By way of example, a user may utilize a given mounting bolt 302 to do any of (a) secure a mower motor 300 to a lift arm 340, (b) secure a mower motor 300 to a mounting plate 390, or (b) store the mounting bolt 302 in fastener passage 384 or a fastener passage 414. The mounting bolts 302 may be interchangeable between mower decks 80.

Referring generally to the figures, a user may reconfigure the mower 10 from operating configuration to the service configuration by (a) disconnecting or removing the mower motors 300 from the corresponding mower decks 80, (b) disconnecting or removing the mower decks 80 from the frame 12, and (c) coupling the mower motors 300 to the respective mounting plates (e.g., the float plates 352 or the mounting plate 390). The reverse of this process may be followed to reconfigure the mower 10 from the service configuration to the operating configuration.

To disconnect the mower motors 300 from the mower decks 80, the mounting bolts 302 for each mower motor 300 may be loosened and removed (e.g., using a wrench). At this point, the mower motors 300 may hang freely from the frame 12 by the cables 310. The user may disconnect the mower decks 80 from the frame 12 by removing the posts 86 from the corresponding receivers 322. By way of example, a post 86 may be released from a receiver 322 by removing a retaining pin.

A mower motor 300 may be coupled to a float plate 352 by aligning two of the fastener apertures 304 with the fastener passage 380 and the fastener passage 382. A first mounting bolt 302 may be inserted through a fastener aperture 304 and into the fastener passage 380, and a second mounting bolt 302 may be inserted through a fastener aperture 304 and into the fastener passage 380. The first and second mounting bolts 302 may be tightened (e.g., using a wrench) to fix the mower motor 300 to the float plate 352. A third mounting bolt 302 may be inserted into the fastener passage 384 and tightened to fix the third mounting bolt 302 to the float plate 352. A similar process may be followed to couple a mower motor 300 to a mounting plate 390.

As utilized herein with respect to numerical ranges, the terms “approximately,” “about,” “substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules, and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the mower 10 and the systems and components thereof (e.g., the body 20, the operator controls 40, the driveline 50, the suspension system 60, the braking system 70, the control system 100, etc.) as shown in the various exemplary embodiments is illustrative only. Additionally, any element disclosed in one embodiment may be incorporated or utilized with any other embodiment disclosed herein. By way of example, the mower deck 80F shown in FIG. 4 may be interchanged with the mower deck 80R shown in FIG. 12A.

1. A mower, comprising:
a chassis;
a tractive element coupled to the chassis;
a cutting unit coupled to the chassis and including a cutting element;
a mounting bracket coupled to the chassis; and
a motor configured to drive the cutting element, wherein the motor is configured to be removably coupled to the cutting unit and configured to be removably coupled to the mounting bracket,
wherein the mower is reconfigurable between (a) an operating configuration in which the motor is removed from the mounting bracket and coupled to the cutting unit and (b) a service or transportation configuration in which the motor is removed from the cutting unit and coupled to the mounting bracket.

2. The mower of claim 1, wherein the mounting bracket is pivotally coupled to the chassis such that the motor is repositionable relative to the chassis while in the service or transportation configuration.

3. The mower of claim 1, further comprising a lift arm coupling the cutting unit to the chassis and including the mounting bracket, wherein the lift arm is pivotally coupled to the chassis.

4. The mower of claim 3, further comprising a pin coupled to the chassis, wherein the mounting bracket defines a slot that receives the pin, and wherein the pin is configured to move along the slot in response to an upward movement of the cutting unit.

5. The mower of claim 4, further comprising a lift actuator coupled to the pin and the chassis and configured to move the pin relative to the chassis to raise the cutting unit.

6. The mower of claim 4, wherein the slot is a first slot, wherein the lift arm further includes a float bracket fixedly coupled to the mounting bracket and defining a second slot that receives the pin, wherein the motor overhangs the float bracket when the mower is in the service or transportation configuration.

7. The mower of claim 1, wherein the mounting bracket is fixedly coupled to the chassis.

8. The mower of claim 7, wherein the chassis includes an operator platform configured to support an operator, wherein the mounting bracket is directly coupled to the operator platform and extends below the operator platform.

9. The mower of claim 1, wherein the motor defines a fastener aperture and the mounting bracket defines a fastener passage, further comprising a fastener configured to extend through the fastener aperture and into the fastener passage to removably couple the motor to the mounting bracket.

10. The mower of claim 9, wherein the fastener aperture is a first fastener aperture, the fastener passage is a first fastener passage, and the fastener is a first fastener, and wherein the motor defines a second fastener aperture and the mounting bracket defines a second fastener passage, further comprising a second fastener that is configured to extend through the second fastener aperture and into the second fastener passage to removably couple the motor to the mounting bracket.

11. The mower of claim 10, wherein the motor includes a motor shaft, wherein the mounting bracket includes a first tab that defines the first fastener passage and a second tab that defines the second fastener passage, and wherein the motor shaft extends through an opening between the first tab and the second tab.

12. The mower of claim 9, wherein the fastener is configured to extend through the fastener aperture and engage the cutting unit to removably couple the motor to the cutting unit.

13. A mower, comprising:
a chassis;
a tractive element coupled to the chassis;
a cutting unit coupled to the chassis and including a cutting element;
an actuator configured to raise the cutting unit relative to the chassis;
a mounting bracket coupled to the chassis, the mounting bracket defining a first fastener passage and a second fastener passage;
a motor configured to drive the cutting element, the motor defining a first fastener aperture and a second fastener aperture; and
a first fastener and a second fastener,
wherein the mower is reconfigurable between:
a first configuration in which (a) the first fastener extends through the first fastener aperture and engages the cutting unit and (b) and the second fastener extends through the second fastener aperture and engages the cutting unit; and
a second configuration in which (a) the first fastener extends through the first fastener aperture and into the first fastener passage to couple the motor to the mounting bracket and (b) the second fastener extends into the second fastener passage without extending through the second fastener aperture.

14. The mower of claim 13, wherein the mounting bracket is fixedly coupled to the chassis.

15. The mower of claim 13, wherein the mounting bracket is pivotally coupled to the chassis.

16. The mower of claim 13, wherein the first fastener passage is threaded to engage the first fastener, and wherein the second fastener passage is threaded to engage the second fastener passage.

17. The mower of claim 13, wherein the mounting bracket defines a third fastener passage and the motor defines a third fastener aperture, further comprising a third fastener, wherein the third fastener extends through the third fastener aperture and engages the cutting unit in the first configuration, and wherein the third fastener extends through the third fastener aperture and into the third fastener passage to couple the motor to the mounting bracket in the second configuration.

18. The mower of claim 13, wherein the cutting unit is removed from the chassis in the second configuration.

19. A mower, comprising:
a chassis;
a tractive element coupled to the chassis;
a first cutting unit configured to be driven by a first motor;
a second cutting unit configured to be driven by a second motor;
a first mounting bracket pivotally coupled to the chassis; and
a second mounting bracket fixedly coupled to the chassis,
wherein the mower is reconfigurable between:
a first configuration in which (a) the first motor is coupled to the first cutting unit and (b) the second motor is coupled to the second cutting unit; and
a second configuration in which (a) the first motor is disconnected from the first cutting unit and coupled to the first mounting bracket and (b) the second motor is disconnected from the second cutting unit and coupled to the second mounting bracket.

20. The mower of claim 19, wherein the first cutting unit and the second cutting unit are disconnected from the chassis in the second configuration.
